(19) United States
(12) Patent Application Publication
(10) Pub. No.: US 2002/0168473 A1
(43) Pub. Date: Nov. 14, 2002

(54) Antimicrobial treatment of porous materials

(75) Inventors: Peter Ottersbach, Windeck (DE); Friedrich Sosna, Dorsten (DE); Friedrich Georg Schmidt, Haltern (DE); Juergen Heidlas, Trostberg (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/137,446

(22) Filed: May 3, 2002

(30) Foreign Application Priority Data
May 8, 2001 (DE) 101 22 149.5

(51) Int. Cl. B05D 3/04; B05D 3/10

(52) U.S. Cl. 427/337

(57) ABSTRACT

The present invention relates to a antimicrobially-treated porous materials and a process for impregnating porous materials with antimicrobial polymers using supercritical media.

### BACKGROUND OF INVENTION

1. Field of the Invention

The present invention relates to a process for preparing porous materials having antimicrobial properties by impregnating them with antimicrobial polymers.

2. Discussion of the Background

Porous materials having large surface area are very susceptible to microbial infestation. Microbial infestation of porous materials ruins the appearances of the materials and eventually leads directly to mechanical defects and breakdown of the materials. In extreme cases where the microbial infestation spreads throughout the materials, complete destruction of the porous materials may result. Such processes of microbial breakdown of porous materials are known as biocorrosion.

Molds, such as Aspergillus niger, are known to cause biocorrosion. Molds penetrate the pores of porous materials such as concrete, sandstone, wood, or glass. The metabolism of molds occupying pores of porous materials causes the gradual destruction of the surfaces of porous materials.

The metabolic products released by molds occupying the pores of porous materials may lead to impaired health in humans. For example, humans may be susceptible to allergies when in contact with such metabolic products, which may cause acute shock or chronic sensitizations.

Porous materials that are regularly used outdoors are subject to stress. These materials include wooden constructions, such as wooden houses, garden sheds, tool sheds, railroad ties, wooden swings, park benches, and wooden bridges. Outdoor materials are susceptible to stress caused by various temperature and moisture conditions. Furthermore, these porous materials for outdoor use are very sensitive to stress associated with microbial infestations.

At a time prior to the present invention, biocorrosion has been combated with two methods. First, a protective layer of hydrophobic coating is applied to the surface of porous materials to prevent water and microbes from contacting the surface. However, this method is only effective for short periods of time because microbes find ways to attach themselves to hydrophobic the surfaces. Second, low molecular mass biocides are added to coating materials and then applied to the surfaces of the porous materials. However, this method does not endure long exposures to moisture because such coatings have been shown to wash away from the surface of the porous material after just one downpour of rain. Therefore, this method is generally reserved for interior use, such as for coating frescoes, sculptures, and paintings.

In order to increase the longevity of protection to porous materials used outdoors, coatings containing biocides have been impregnated by vacuum pressure. However, such biocides are toxic to humans as they eventually leech out of the treated porous material.

U.S. Pat. No. 5,094,892 describes a process in which a wood preservative can be introduced into wood materials by means of a supercritical solvent, such as carbon dioxide, and a cosolvent. The supercritical solvent and the cosolvent are first mixed. Then, the mixture takes up the wood preservative. Finally, this mixture is used to impregnate the wood under supercritical conditions. Unfortunately, wood preservatives are not very soluble in the supercritical solvent. In fact, only wood preservatives containing copper compounds have been found to be soluble in the supercritical solvent. Copper compounds are hazardous to the environment; and therefore, are preferred for use.

European patent application 0 862 858 describes that copolymers of tert-butlyaminoethyl methacrylate, a methacrylate ester with a secondary amino function, is antimicrobial. Furthermore, the three-dimensional structure, conformation, and available surface area of these polymer systems are attributed to their antimicrobial activity. They are well suited for applications where the sustainable long-lasting protection of a surface from microbial infestation is desired.

The German patent application 10 062 201.1 describes using antimicrobial polymers in the preservation of buildings and monuments. However, this process does not permit adequate penetration of antimicrobial polymers into the treated materials. As a result, the surface suffers mechanical damage that may result in the destruction of the material's protection.

German Patent Application 101 22 149.5 describes using supercritical media to impregnate materials. However, the high pressures and specific equipment needed are very complicated.

Prior to the present invention, it was not known how to introduce antimicrobial materials to the surfaces of porous materials using supercritical media with adequate depth penetration into such surfaces in order to protect the porous materials from microbial infestation and subsequent deterioration for extended periods of time.

### SUMMARY OF THE INVENTION

One object of the present invention is to protect porous materials from microbial infestation and subsequent deterioration for extended periods of time.

Another object of the present invention is to provide methods of impregnating porous materials with antimicrobial polymers at adequate depth penetration into the surface of such porous materials.

Another object of the present invention is to provide methods of impregnating porous materials with antimicrobial polymers by introducing the antimicrobial polymers into the matrix of porous materials with supercritical media.

Another object of the present invention is to provide methods of impregnating porous materials with antimicrobial polymers by applying a solution or dispersion of an antimicrobial polymer to the porous material and then introducing it into the porous material with a supercritical medium.

Another object of the present invention is to provide a porous material impregnated with antimicrobial polymers by applying a solution or dispersion of the antimicrobial polymer to the porous material and then introducing it into the porous material with a supercritical medium.

The objects of the present invention may be accomplished by a process comprising contacting a solution or a dispersion of an antimicrobial polymer to a porous material and then contacting the porous material with a supercritical medium.

The above descriptions highlight certain aspects and embodiments of the present invention. The objects of the present invention may be also accomplished by the additional objects, aspects, and embodiments of the present invention that follow in the detailed description of the present invention considered together with the Examples and Figures.

### DETAILED DESCRIPTION OF THE PRESENT INVENTION

Unless specifically defined, all technical and scientific terms used herein have the same meaning as commonly understood by a skilled artisan in biochemistry, chemistry, and materials science.

Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. Further, the materials, methods, and examples are illustrative only and are not intended to be limiting.

In the process of the present invention, an antimicrobial polymer may be dissolved in a solvent such as an organic solvent. Suitable solvents include but are not limited to alcohols such as ethanol, methanol, propanol, and isopropanol, acetates such as ethyl acetate, and butyl acetate, ketones such as acetone and methyl ethyl ketone, and aromatics such as toluene and xylene. Alternatively, the antimicrobial polymer may be dispersed in an aqueous solvent. Suitable dispersion media include but are not limited to emulsifiers such as polyethylene glycol derivatives.

The solution or dispersion may then be applied to the surface of a porous material. Application of the solution or dispersion to the surface of a porous material may occur by brushing, spraying, or immersing the porous material into the solution or dispersion. The solution or dispersion of the antimicrobial polymer may dry on the porous material. Alternatively, the solvent or dispersion material may be removed by distillation for example. This application is considered a pretreatment of the porous material whether or not the solvent or dispersion is dried or removed.

The pretreated porous material may then be exposed to a supercritical medium. Suitable supercritical medium includes carbon dioxide and propane. The supercritical medium carries the antimicrobial polymer deep into the pores of the pretreated porous material. If carbon dioxide is used as the supercritical medium, the process is conducted preferably at a pressure from 50 to 500 bar, more preferably from 200 to 300 bar, at a temperature from 10° C. to 150° C., more preferably from 30° C. to 80° C. The ranges for the pressure include all specific values and subranges therebetween, such as 75, 100, 125, 150, 175, 200, 225, 250, 275, 300, 325, 350, 375, 400, 425, 450, and 475 bar. The ranges for the temperature include all specific values and subranges therebetween, such as 20, 30, 40, 50, 60, 70, 80, 90, 100, 110, 120, 130, and 140° C.

The antimicrobial property is inherently in the polymer itself. Therefore, leeching of the active antimicrobial species is fundamentally impossible. Furthermore, the antimicrobial polymers possess hydrophilic groups. Such hydrophilic groups swell when in contact with water or moisture, completely filling the pores in which the antimicrobial polymers reside. Water or moisture is required for microbial attack of porous materials. Therefore, the presence of water or moisture leads the polymer to swell and seal off the polymer from microbial infestation. Furthermore, the antimicrobial polymer is much less toxic than low molecular mass biocides, leading to less potential toxicity to humans when the antimicrobial polymer is impregnated into the porous material.

As a result of treating porous materials according to the above, the present invention provides a method of providing porous materials that are durable and resistant to environmental influences and physical stresses. Further, the treated porous materials possess no low molecular mass biocides that can leech from their pores, reducing the odds that environmentally toxic substances will migrate from the porous material throughout use of the porous material.

The process according to the present invention particularly prefers the antimicrobial polymers to be prepared from monomers such as 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-(3-dimethylaminopropyl) acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, allyltriphenylphosphonium bromide, allyltriphynylphosphonium chloride, 2-acrylamido-2-methyl-1-propanesulfonic acid, 2-diethylaminothyl vinyl ether, and/or 3-aminopropyl vinyl ether.

The antimicrobial polymers are to be prepared from the above-mentioned monomers. The weight-average molecular weight of the antimicribial polymers according to the present invention is preferably from 10,000 to 7,000,000, more preferably from 20,000 to 5,000,000. The ranges for the weight-average molecular weight of the antimicribial polymers include all specific values and subranges therebetween, such as 50,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000, 1,000,000, 1,050,000, 1,100,000, 1,150,000, 1,200,000, 1,250,000, 1,300,000, 1,350,000, 1,400,000, 1,450,000, 1,500,000, 1,550,000, 1,600,000, 1,700,000, 1,750,000, 1,800,000, 1,850,000, 1,900,000, 1,950,000, 2,000,000, 2,050,000, 2,100,000, 2,150,000, 2,200,000, 2,250,000, 2,300,000, 2,350,000, 2,400,000, 2,450,000, 2,500,000, 2,550,000, 2,600,000, 2,650,000, 2,700,000, 2,750,000, 2,800,000, 2,850,000, 2,900,000, 2,950,000, 3,000,000, 3,050,000, 3,100,000, 3,150,000, 3,200,000, 3,250,000, 3,300,000, 3,350,000, 3,400,000, 3,450,000, 3,500,000, 3,550,000, 3,600,000, 3,650,000, 3,700,000, 3,750,000, 3,800,000, 3,850,000, 3,900,000, 3,950,000, 4,000,000, 4,050,000, 4,100,000, 4,150,000, 4,200,000, 4,250,000, 4,300,000, 4,350,000, 4,400,000, 4,450,000, 4,500,000, 4,550,000, 4,600,000, 4,650,000, 4,700,000, 4,750,000, 4,800,000, 4,850,000, 4,900,000, 4,950,000, 5,000,000, 5,050,000, 5,100,000, 5,150,000, 5,200,000, 5,250,000, 5,300,000, 5,350,000, 5,400,000, 5,450,000, 5,500,000, 5,550,000, 5,600,000, 5,650,000, 5,700,000, 5,750,000, 5,800,000, 5,850,000, 5,900,000, 5,950,000, 6,000,000, 6,050,000, 6,100,000, 6,150,000, 6,200,000, 6,250,000, 6,300,000, 6,350,000, 6,400,000, 6,450,000, 6,500,000, 6,550,000, 6,600,000, 6,650,000, 6,700,000, 6,750,000, 6,800,000, 6,850,000, 6,900,000, and 6,950,000.

The supercritical medium may or may not be used alone. In addition, a further solvent may be used which facilitates the impregnation of the antimicrobial polymer into the porous material. Suitable solvents include those mentioned above.

The present invention discloses a novel process for treating porous materials with antimicrobial polymers. Examples of porous materials that may be treated according to the process of present of present invention are natural stone, artificial stone, mineral, concrete, wood, plaster, glass, clay, cement, mortar, ceramic, and combinations thereof.

Once the porous materials are treated according to the present invention, they may be used in the protection of the surfaces of constructions, buildings, and monuments. The building materials of such surface-protected constructions, buildings, and monuments may be natural stone, artificial stone, mineral, concrete, wood, plaster, glass, clay, cement, mortar, ceramic, and combinations thereof that have surfaces impregnated with the antimicrobial polymers according to the process of the present invention.

The present invention is explained in more detail with the aid of the following embodiment examples. As can be seen from the following examples, the process according to the present invention can significantly reduce microbial infestation of the surfaces of porous materials.

### EXAMPLES

Numerous modifications and variations on the present invention are possible in light of the above teachings. The following embodiment examples are in no way intended to narrow the scope of the teachings described above. Alternatively, the following examples demonstrate that the that present invention can significantly reduce microbial infestation of the surfaces of porous materials.

### Example 1

50 mL of dimethylaminopropyl methacrylamide (from Aldrich) and 250 mL of ethanol placed in a three-necked flask and heated to 65° C. under a stream of argon. Then, 0.6 g of azobisisobutyronitrile dissolved in 20 mL of ethyl methyl ketone is added slowly dropwise while stirring. The mixture is heated to 70° C. and stirred at this temperature for 72 hours. After this time, the reaction mixture is stirred into 1.5 L of distilled water and the polymeric produce precipitates. After the product has been filtered off, the filter residue is washed with 100 mL of a 1:1 mixture of ethanol/distilled water in order to remove any residual monomers still present. Thereafter, the product is vacuum-dried at 50° C. for 24 hours.

A bar of sprucewood measuring 40 by 40 by 300 mm is immersed for one hour at room temperature in one liter of a solution of 5% by weight of the polymeric product and 95% by weight of ethanol. The bar thus pretreated is then placed in an autoclave. Supercritical carbon dioxide is injected to 250 bar at 40° C. These conditions are maintained for one hour. After the system has been let down, the bar is removed from the autoclave and dried at 30° C. under 50 mbar of pressure for two days.

### Example 1a

One drop of a microbe suspension of Staphylococcus aureus containing a microbe count of 107 microbes/mL is applied to the bar from Example 1. After a contact time of 4 hours, the drop is removed with a pipette and the microbe count of the test mixture is determined. After this time, Staphylococcus aureus microbes are no longer detectable.

### Example 1b

One drop of a microbe suspension of Pseudomonas aeruginosa containing a microbe count of 107 microbes/mL is applied to the bar from Example 1. After a contact time of 4 hours, the drop is removed with a pipette and the microbe count of the test mixture is determined. After this time, Pseudomonas aeruginosa microbes are no longer detectable.

### Example 1c

Impregnated bars from Example 1 are each inoculated with Chlorella sp., Trentepohilia sp., Gloeocapsa sp., Calothrix sp., or Aspergillus niger. These samples are then kept in an incubator for 3 weeks . In contrast to control samples undergoing the same test, infestation is found on none of the impregnated bars of wood.

### Example 2

50 mL of tert-butylaminoethyl methacrylate (from Aldrich) and 250 mL of ethanol are placed in a three-necked flask and heated to 65° C. under a stream of argon. Then, 0.6 g of azobisisobutyronitrile dissolved in 20 mL of ethyl methyl ketone is added slowly dropwise while stirring. The mixture is heated to 70° C. and stirred at this temperature for 72 hours. After this time, the reaction mixture is stirred into 1.5 L of distilled water and the polymeric produce precipitates. After the product has been filtered off, the filter residue is washed with 100 mL of a 1:1 mixture of ethanol/distilled water in order to remove any residual monomers still present. Thereafter, the product is vacuum-dried at 50° C. for 24 hours.

A bar of sprucewood measuring 40 by 40 by 300 mm is immersed for one hour at room temperature in one liter of a solution of 5% by weight of the polymeric product and 95% by weight of ethanol. The bar thus pre-treated is then placed in an autoclave. Supercritical carbon dioxide is injected to 250 bar at 40° C. These conditions are maintained for one hour. After the system has been let down, the bar is removed from the autoclave and dried at 30° C. under 50 mbar of pressure for two days.

### Example 2a

One drop of a microbe suspension of Staphylococcus aureus containing a microbe count of 107 microbes/mL is applied to the bar from Example 2. After a contact time of 4 hours, the drop is removed with a pipette and the microbe count of the test mixture is determined. After this time, Staphylococcus aureus microbes are no longer detectable.

### Example 2b

One drop of a microbe suspension of Pseudomonas aeruginosa containing a microbe count of 107 microbes/mL is applied to the bar from Example 2. After a contact time of 4 hours, the drop is removed with a pipette and the microbe count of the test mixture is determined. After this time, Pseudomonas aeruginosa microbes are no longer detectable.

### Example 2c

Impregnated bars from Example 2 are each inoculated with Chlorella sp., Trentepohilia sp., Gloeocapsa sp., Calothrix sp., or Aspergillus niger. These samples are then kept in an incubator for 3 weeks . In contrast to control samples undergoing the same test, infestation is found on none of the impregnated bars of wood.

### Example 3

20 mL of tert-butylaminoethyl methacrylate (from Aldrich) and 0.2 g of azobisisobutyronitrile are placed in a glass ampoule. The ampoule is sealed and placed in a waterbath at 70° C. for 6 hours. After this time, the ampoule is removed, cooled to room temperature, and opened. The polymeric product is taken out and ground with a mortar.

A bar of sprucewood measuring 10 by 10 by 80 mm is placed in an autoclave with a volume of one liter. Then, a solution of 5% by weight of the polymeric product and 95% by weight of ethanol is introduced into the autoclave until the autoclave is full to two-third's volume. The autoclave is sealed and supercritical carbon dioxide is injected to 250 bar at 40° C. These conditions are maintained for one hour. After the system has been let down, the bar is removed from the autoclave and dried at 30° C. under 50 mbar of pressure for two days.

### Example 3a

One drop of a microbe suspension of Staphylococcus aureus containing a microbe count of 107 microbes/mL is applied to the bar from Example 3. After a contact time of 4 hours, the drop is removed with a pipette and the microbe count of the test mixture is determined. After this time, Staphylococcus aureus microbes are no longer detectable.

### Example 3b

One drop of a microbe suspension of Pseudomonas aeruginosa containing a microbe count of 107 microbes/mL is applied to the bar from Example 3. After a contact time of 4 hours, the drop is removed with a pipette and the microbe count of the test mixture is determined. After this time, Pseudomonas aeruginosa microbes are no longer detectable.

### Example 3c

Impregnated bars from Example 3 are each inoculated with Chlorella sp., Trentepohilia sp., Gloeocapsa sp., Calothrix sp., or Aspergillus niger. These samples are then kept in an incubator for 3 weeks . In contrast to control samples undergoing the same test, infestation is found on none of the impregnated bars of wood.

### Example 4

20 mL of tert-butylaminoethyl methacrylate (from Aldrich) and 0.2 g of azobisisobutyronitrile are placed in a glass ampoule. The ampoule is sealed and placed in a waterbath at 70° C. for 6 hours. After this time, the ampoule is removed, cooled to room temperature, and opened. The polymeric product is taken out and ground with a mortar.

A bar of sandstone measuring 10 by 10 by 80 mm is placed in an autoclave with a volume of one liter. Then, a solution of 5% by weight of the polymeric product and 95% by weight of ethanol is introduced into the autoclave until the autoclave is full to two-third's volume. The autoclave is sealed and supercritical carbon dioxide is injected to 250 bar at 40° C. These conditions are maintained for one hour. After the system has been let down, the bar is removed from the autoclave and dried at 30° C. under 50 mbar of pressure for two days.

### Example 4a

One drop of a microbe suspension of Staphylococcus aureus containing a microbe count of 107 microbes/mL is applied to the bar from Example 4. After a contact time of 4 hours, the drop is removed with a pipette and the microbe count of the test mixture is determined. After this time, Staphylococcus aureus microbes are no longer detectable.

### Example 4b

One drop of a microbe suspension of Pseudomonas aeruginosa containing a microbe count of 107 microbes/mL is applied to the bar from Example 4. After a contact time of 4 hours, the drop is removed with a pipette and the microbe count of the test mixture is determined. After this time, Pseudomonas aeruginosa microbes are no longer detectable.

### Example 4c

Impregnated bars from Example 4 are each inoculated with Chlorella sp., Trentepohilia sp., Gloeocapsa sp., Calothrix sp., or Aspergillus niger. These samples are then kept in an incubator for 3 weeks . In contrast to control samples undergoing the same test, infestation is found on none of the impregnated bars of wood.

The present application claims priority to German Application No. DE 10122419.5, filed on May 8, 2001, which is hereby incorporated by reference in its entirety.

Numerous modifications and variations on the present invention are possible in light of the above teachings. It is, therefore, to be understood that within the scope of the accompanying claims, the invention may be practiced otherwise than as specifically described herein.

What is claimed is:

1. A process for impregnating a porous material with an antimicrobial polymer, comprising:
applying a solution or a dispersion media comprising an antimicrobial polymer to a porous material; and then
contacting the porous material with a supercritical medium.

2. The process according to claim 1, wherein the solution or dispersion media comprising the antimicrobial polymer is dried on the porous material before contacting the porous material with a supercritical medium.

3. The process according to claim 1, wherein the solution or dispersion media is removed from the porous material, leaving the antimicrobial polymer in contact with the porous material, before the porous material is contacted with a supercritical medium.

4. The process according to claim 1, wherein the porous material comprises at least one member selected from the group consisting of natural stone, artificial stone, mineral, concrete, wood, plaster, glass, clay, cement, mortar, and ceramic.

5. The process according to claim 1, wherein the antimicrobial polymers are prepared from at least one member selected from the group consisting of a nitrogen-functionalized monomer and a phosphorus-functionalized monomer.

6. The process according to claim 1, wherein the supercritical medium comprises carbon dioxide.

7. The process according to claim 1, wherein the antimicrobial polymer is prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminpropyl acrylate, 2-diethylaminoethyl acrylate, , 2-dimethylaminoethyl acrylate, dimethylaminopropylmethacrylamide, diethylaminopropylmethacrylamide, N-(3-dimethylaminopropyl) acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, allyltriphenylphosphonium bromide, allyltriphynylphosphonium chloride, 2-acrylamido-2-methyl-1-propanesulfonic acid, 2-diethylaminothyl vinyl ether, and 3-aminopropyl vinyl ether.

8. The process according to claim 1, wherein the porous material contacts the supercritical medium at a pressure from 50 to 500 bar.

9. The process according to claim 1, wherein the porous material contacts the supercritical medium at a temperature from 10° C. to 150° C.

10. The process according to claim 1, wherein the solution comprising the antimicrobial polymer further comprises at least one member selected from the group consisting of ethanol, methanol, propanol, isopropanol, ethyl acetate, butyl acetate, acetone, methyl ethyl ketone, toluene, and xylene.

11. The process according to claim 1, wherein the dispersion media comprising the antimicrobial polymer further comprises a polyethylene glycol derivative.

12. The process according to claim 1, wherein the solution or the dispersion media comprising the antimicrobial polymer is applied to the porous material by brush, spray, or immersion.

13. The process according to claim 1, wherein the porous material is contacted with the supercritical medium in the presence of a solvent comprising at least one member selected from the group consisting of ethanol, methanol, propanol, isopropanol, ethyl acetate, butyl acetate, acetone, methyl ethyl ketone, toluene, and xylene.

14. The process according to claim 13 wherein the antimicrobial polymer comprises a weight-average molecular weight of from 10,000 to 7,000,000.

15. The process according to claim 1, wherein the antimicrobial polymer comprises a weight-average molecular weight of from 20,000 to 5,000,000.

16. A porous material made by the process according to claim 1.

17. A building, comprising the porous material according to claim 16.

18. A monument, comprising the porous material according to claim 16.

19. A construction, comprising the porous material according to claim 16.

20. A process for preparing a construction, building, or monument, comprising
applying a solution or dispersion comprising an antimicrobial polymer to a porous material; and then
contacting the porous material with a supercritical medium; and then
using the porous material as a building material of a construction, building, or monument.

21. A process of impregnating porous materials with an antimicrobial polymer, comprising contacting a porous material to which an antimicrobial polymer has been applied with a supercritical medium.

22. The process according to claim 21, wherein the porous material comprises at least one member selected from the group consisting of natural stone, artificial stone, mineral, concrete, wood, plaster, glass, clay, cement, mortar, and ceramic.

23. The process according to claim 21, wherein the antimicrobial polymers are prepared from at least one member selected from the group consisting of a nitrogen-functionalized monomer and a phosphorus-functionalized monomer.

24. The process according to claim 21, wherein the supercritical medium comprises carbon dioxide.

25. The process according to claim 21, wherein the antimicrobial polymer is prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminpropyl acrylate, 2-diethylaminoethyl acrylate, , 2-dimethylaminoethyl acrylate, dimethylaminopropylmethacrylamide, diethylaminopropylmethacrylamide, N-(3-dimethylaminopropyl) acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, allyltriphenylphosphonium bromide, allyltriphynylphosphonium chloride, 2-acrylamido-2-methyl-1-propanesulfonic acid, 2-diethylaminothyl vinyl ether, and 3-aminopropyl vinyl ether.

26. The process according to claim 21, wherein the porous material to which an antimicrobial polymer has been applied contacts the supercritical medium at a pressure from 50 to 500 bar.

27. The process according to claim 21, wherein the porous material to which an antimicrobial polymer has been applied contacts the supercritical medium at a temperature from 10° C. to 150° C.

28. The process according to claim 21, wherein the porous material to which an antimicrobial polymer has been applied is contacted with the supercritical medium in the presence of a solvent comprising at least one member selected from the group consisting of ethanol, methanol, propanol, isopropanol, ethyl acetate, butyl acetate, acetone, methyl ethyl ketone, toluene, and xylene.

29. The process according to claim 21, wherein the antimicrobial polymer comprises a weight-average molecular weight of from 10,000 to 7,000,000.

30. The process according to claim 21, wherein the antimicrobial polymer comprises a weight-average molecular weight of from 20,000 to 5,000,000.

31. A porous material made by the process according to claim 21.

32. A building, comprising the porous material according to claim 31.

33. A monument, comprising the porous material according to claim 31.

34. A construction, comprising the porous material according to claim 31.

35. A process for preparing a construction, building, or monument, comprising
applying a solution or dispersion comprising an antimicrobial polymer to a porous material; and then
contacting the porous material with a supercritical medium; and then
using the porous material as a building material of a construction, building, or monument.
